(19) United States
(12) Patent Application Publication
(10) Pub. No.: US 2006/0290279 A1
(43) Pub. Date: Dec. 28, 2006

(54) Plasma display panel

(76) Inventors: Min Hur, Suwon-si (KR); Min-Sun Yoo, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/475,007

(22) Filed: Jun. 27, 2006

(30) Foreign Application Priority Data
Jun. 27, 2005 (KR) 10-2005-0055712

(51) Int. Cl. H01J 17/49

(52) U.S. Cl. 313/582; 313/585

(57) ABSTRACT

A plasma display panel (PDP) having low voltage sustain discharge, increased luminous efficiency and independent control of any two adjacent discharge cells, includes a first substrate and a second substrate arranged opposite to each other, a dielectric layer defining a plurality of discharge cells between the first substrate and the second substrate, a phosphor layer in each discharge cell, address electrodes extending in a first direction between the first substrate and the second substrate, and first electrodes and second electrodes disposed opposite and spaced apart each other in the dielectric layer and extending in a second direction crossing the first direction. The height of the first and second electrodes span from the first substrate toward the second substrate.

### BACKGROUND OF THE INVENTION

1. Field of the Invention

The present invention relates to a plasma display panel (PDP). More particularly, the present invention relates to a PDP in which two adjacent discharge cells can be independently controlled in an opposed discharge structure.

2. Description of the Related Art

A three-electrode surface-discharge type PDP may include one substrate having sustain electrodes and scan electrodes formed on a same surface, and another substrate that is spaced therefrom by a predetermined distance having address electrodes perpendicular to the sustain and the scan electrodes. A discharge gas may be provided between the substrates.

A discharge may be determined and effected by the discharge of the address electrodes and the scan electrodes that are respectively connected to electrical leads or lines and are independently controlled, and a sustain discharge for displaying a screen may be effected and realized by the sustain electrodes and the scan electrodes that are located on the same surface.

PDPs generate visible light using glow discharge, and several steps may be performed from the step of generating glow discharge to the step in which visible light may be viewed. That is, if the glow discharge is generated, gas is excited by collisions of electrons and excited gas or plasma is generated. This excited gas or plasma generates ultraviolet (UV) light photons or rays. The UV light may collide with a phosphor layer in a discharge cell to generate visible light, and the visible light may pass through a transparent substrate to be viewed. In these steps, significant input energy applied to the sustain electrode and the scan electrode is lost or dissipated.

The glow discharge may be generated by applying a voltage higher than a discharge firing voltage to two electrodes. That is, in order to initiate this discharge, a significantly high voltage is required. If the discharge is generated, a voltage distribution between an anode and a cathode may be distorted by a space charge effect generated in a dielectric layer adjacent to the anode and the cathode. Typically, three regions may be formed between the two electrodes: a cathode sheath region adjacent to the cathode that may consume most of the voltage applied to the two electrodes for discharge, an anode sheath region adjacent to the anode that may consume a portion of the voltage, and a positive column region formed between the two regions that may consume very little voltage. In the cathode sheath region, electron heating efficiency depends on a secondary electron coefficient of a magnesium oxide (MgO) protective film formed on the dielectric layer, and in the positive column region, most of the input energy is consumed for electron heating.

Vacuum UV (VUV) light for colliding with the phosphor layer and emitting visible light may be generated when xenon (Xe) gas in an excitation state is transitioned to a ground state. The excitation state of Xe gas occurs by the collision of Xe gas and electrons. Accordingly, in order to increase a ratio of the input energy for generating visible light (that is, luminous efficiency), the number of collisions of Xe gas and the electrons must be increased. Also, in order to increase the number of collisions of Xe gas and the electrons, the electron heating efficiency must be increased.

While the cathode sheath region consumes most of the input energy, it has a low electron heating efficiency. In contrast, while the positive column region consumes very little input energy, it has a high electron heating efficiency. Accordingly, by increasing the positive column region (discharge gap), high luminous efficiency can be obtained.

Moreover, it is known that, in the ratio of electrons that are consumed according to a change in a ratio E/n of electric field E across discharge gaps (positive column region) to gas density n, the electron consuming ratio in the same ratio E/n increases in the order of xenon excitation (Xe*), xenon ion (Xe⁺), neon excitation (Ne*), and neon ion (Ne⁺). Also, it is known that, in the same ratio E/n, the electron energy decreases as the partial pressure of Xe gas increases. That is, if the electron energy decreases, the partial pressure of Xe gas increases. Also, if the partial pressure of Xe gas increases, the ratio of electrons that are consumed for exciting Xe gas increases, among xenon excitation (Xe*), xenon ion (Xe⁺), neon excitation (Ne*), and neon ion (Ne⁺), thereby improving luminous efficiency.

As described above, incremental increase of the positive column region may increase the electron heating efficiency. Also, incremental increase in the partial pressure of Xe gas may increase the electron heating ratio consumed for xenon excitation (Xe*) in the electrons. Accordingly, by incremental increase of the positive column region and the partial pressure of Xe gas, the electron heating efficiency increases and thus the luminous efficiency may be improved.

However, there is a problem in that incremental increase of the positive column region and the partial pressure of Xe gas increases a discharge firing voltage and the cost for manufacturing the PDP. Accordingly, in order to increase the luminous efficiency, incremental increase of the positive column region and the partial pressure of Xe gas needs to be realized at a low discharge firing voltage.

It is known that, in a case of using the same discharge gap distance and the same pressure, the discharge firing voltage required for the surface discharge structure is higher than the discharge firing voltage required for the opposed discharge structure. In the meantime, two adjacent discharge cells need to be disposed to share the sustain electrode or the scan electrode in the opposed discharge structure in order to decrease non-luminous regions and to increase the luminous efficiency.

However, when corresponding voltages are applied to the address electrode and the scan electrode in the PDP, respectively, two discharge cells adjacent to a length direction of the address electrode may be selected together in error. As a result of this faulty address selection of two adjacent discharge cells, problems relating to faulty sustain discharge and faulty display quality may result.

The above information disclosed in this Background section is provided only for the purpose of aiding and enhancing an understanding of the basis and background of the present invention, and does not constitute, and is not to be interpreted as, an admission or statement as to what is or is not considered or constitutes prior art relative to the present invention.

### SUMMARY OF THE INVENTION

The present invention is therefore directed to a plasma display panel (PDP), which substantially overcomes one or more of the problems due to the limitations and disadvantages of the prior art.

It is therefore a feature of an embodiment of the present invention to provide a PDP that performs sustain discharge with a low voltage.

It is therefore another feature of an embodiment of the present invention to provide a PDP having increased luminous efficiency.

It is therefore yet another feature of an embodiment of the present invention to independently control two adjacent discharge cells in a PDP.

At least one of the above and other features and advantages of the present invention may be realized by providing a plasma display panel having a first substrate and a second substrate arranged opposite to each other, a dielectric layer defining a plurality of discharge cells between the first substrate and the second substrate, with at least three discharge cells forming a display pixel of the display panel being disposed in a triangular pattern, a phosphor layer in each discharge cell, address electrodes extending in a first direction between the first substrate and the second substrate, with each discharge cell of the at least three discharge cells forming the display pixel of the display panel being paired with a different address electrode, and a first electrode and a second electrode, disposed opposite and spaced apart from each other in the dielectric layer, and each other in the dielectric layer, and extending in a second direction crossing the first direction.

The dielectric layer may include first dielectric members extending in the second direction and second dielectric members alternately disposed along the first direction between the first dielectric members and connecting the first dielectric members to each other.

Each address electrode may include a small electrode portion and a large electrode portion, the small electrode portion being adjacent or beside the second dielectric members and the large electrode portion being adjacent or beside the discharge cells. A gap may exist between an external circumference of the large electrode portion and an internal circumference of the discharge cell. A width of the large electrode portion corresponding to a center of the discharge cell may be less than a width of the large electrode portion adjacent to the first electrodes or the second electrodes, the width being measured in the second direction. The address electrodes may further include a groove along a side of the large electrode portion extending in the first direction. The groove may be arc shaped, and the arc may be concave relative to the exterior of the discharge cell immediately adjacent the groove.

The address electrodes may further include a transitional electrode portion formed between the large electrode portion and the small electrode portion, as well as an arc shaped groove along a side of the large electrode portion extending in the first direction. Alternatively, at least one side of the large electrode portion in the first direction may be straight, and a width of the large electrode portion in each discharge cell may be constant.

The discharge cells may have a variety of shapes, including a quadrilateral shape, a hexagonal shape, etc. When the discharge cells have a hexagonal shape, the first electrode and the second electrode are formed in a zigzag pattern along circumferences of the discharge cells and extend in the second direction.

The plasma display panel may further have a first barrier rib layer disposed adjacent to the first substrate, wherein the dielectric layer defines a main discharge space and the first barrier rib layer defines a first discharge space in corresponding relationship with the main discharge space. The plasma display panel may further have a second barrier rib layer disposed adjacent to the second substrate, wherein the second barrier rib layer defines a second discharge space in corresponding relationship with the first discharge space with the main discharge space interposed therebetween. A volume of the second discharge space may be greater than a volume of the first discharge space.

The first barrier rib layer may have first barrier rib members in parallel with the first dielectric members and have second barrier rib members in parallel with the second dielectric members, the second barrier rib members alternately connecting adjacent first barrier rib members to each other. The second barrier rib layer may also have third barrier rib members in parallel with the first dielectric members and the first barrier rib member, and fourth barrier rib members in parallel with the second dielectric members and the second barrier rib members, the fourth barrier rib members alternately connecting adjacent third barrier rib members to each other.

The phosphor layer may have a first phosphor layer in the first discharge space defined by the first barrier rib layer, and a second phosphor layer in the second discharge space defined by the second barrier rib layer, wherein the first phosphor layer may be a reflective phosphor and the second phosphor layer may be a transmissive phosphor. The first electrode and the second electrode may be a metal. The first electrode and the second electrode may be disposed at boundaries of adjacent discharge cells across the first direction, and may be alternately arranged across the first direction.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial exploded perspective view of a PDP according to a first exemplary embodiment of the present invention;

FIG. 2 illustrates a schematic partial plan view of the structure of electrodes and discharge cells in the PDP according to the first exemplary embodiment of the present invention;

FIG. 3 illustrates a partial cross-sectional side view taken along line III of the PDP of FIG. 1, during assembly of the PDP; and

FIGS. 4 to 9 illustrate schematic partial plan views of the structure of electrodes and discharge cells in a PDP according to second to seventh exemplary embodiments, respectively, of the present invention.

### DETAILED DESCRIPTION OF THE EMBODIMENTS

Korean Patent Application No. 10-2005-0055712, filed on Jun. 27, 2005, in the Korean Intellectual Property Office and entitled “Plasma Display Panel”, is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

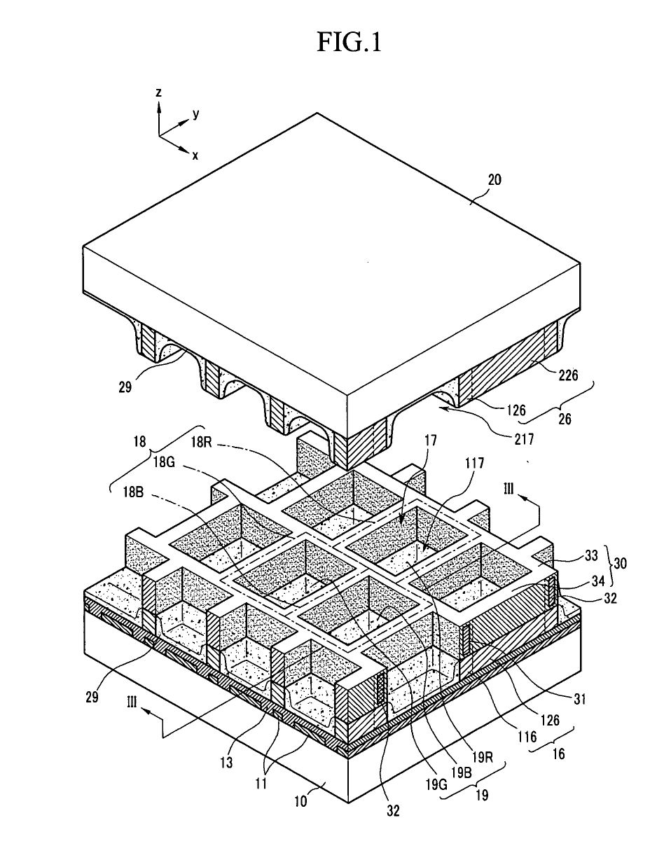

Referring to FIGS. 1-3, a PDP according to a first exemplary embodiment of the present invention may include a first substrate 10 (hereinafter referred to as a “rear substrate”) and a second substrate 20 (hereinafter referred to as “front substrate”) arranged opposite to each other with a predetermined distance therebetween, and a dielectric layer 30 provided between the rear substrate 10 and the front substrate 20 and defining a plurality of discharge cells 18. The dielectric layer 30 may partition a main discharge space 17 between the rear substrate 10 and the front substrate 20 to form pixels of the display panel. Discharge cells 18R (red), 18G (green) and 18B (blue), which in combination form a pixel of the display panel, may be disposed in a triangular pattern or configuration. Phosphor layers 19 that are sensitive to VUV rays and which emit visible red, green or blue light may be provided in each of the discharge cells 18R, 18G and 18B, respectively. The phosphor layers 19 may include phosphor layers 19R, 19G and 19B corresponding to discharge cells 18R, 18G and 18B to emit red, green and blue visible light, respectively. A discharge gas, e.g., a gas mixture containing Xe gas and Ne gas may be provided in the discharge cells 18 so as to generate VUV light by plasma discharge.

Address electrodes 11 may be formed on the rear substrate 10, and first electrodes 31 (hereinafter referred to as “sustain electrodes”) and second electrodes 32 (hereinafter referred to as “scan electrodes”) may be provided with the dielectric layer 30. The address electrodes 11 and the scan electrodes 32 may be disposed in an intersecting configuration relative to each other so that each discharge cell 18R, 18B, and 18G may be individually selected by an address discharge. The sustain electrodes 31 and the scan electrodes 32 may be disposed parallel to each other so that visible light and, hence, visible images may be realized by a sustain discharge.

According to the first exemplary embodiment of the PDP of the present invention, a first barrier rib layer 16 (hereinafter referred to as a “rear-plate barrier rib layer”) may be formed adjacent to the rear substrate 10. The rear-plate barrier rib layer 16 may define a plurality of first discharge spaces 117 that may be connected to the main discharge spaces 17 as defined by the dielectric layer 30.

A second barrier rib layer 26 (hereinafter referred to as a “front-plate barrier rib layer”) may be formed adjacent to the front substrate 20. Phosphor layers 29 may be provided on sides of the front-plate barrier rib layer and 26 and on front substrate 20. The front-plate barrier rib layer 26 may define a plurality of second discharge spaces 217 that may be connected to the first discharge spaces 117 as may be defined by the rear-plate barrier rib layer 16 with the main discharge spaces 17 therebetween. Thus, the first discharge spaces 117 as may be defined by the rear-plate barrier rib layer 16, the main discharge spaces 17 as may be defined by the dielectric layer 30, and the second discharge spaces 217 as may be defined by the front-plate barrier rib layer 26 may be connected to one another in a direction perpendicular to the substrates between the front and rear substrates 20 and 10, respectively, and may thereby form discharge cell 18.

Specifically, the rear-plate barrier rib layer 16 may be formed to protrude from the rear substrate 10 toward the front substrate 20, and the front-plate barrier rib layer 26 may be formed to protrude from the front substrate 20 toward the rear substrate 10. Accordingly, the rear-plate barrier rib layer 16 may define the first discharge spaces 117 adjacent to the rear substrate 10 to form discharge cells 18R, 18G and 18B, and the front-plate barrier rib layer 26 may define the second discharge spaces 217 adjacent to the front substrate 20 to form discharge cells 18R, 18G and 18B. Alternatively, the front-plate barrier rib layer 26 may be formed adjacent the front substrate 20 without forming the rear-plate barrier rib layer 16 adjacent the rear substrate 10.

With the rear-plate barrier rib layer 16 and the front-plate barrier rib layer 26, the dielectric layer 30 may be disposed between the rear-plate barrier rib layer 16 and the front-plate barrier rib layer 26. The dielectric layer 30 may include a first dielectric member 33 and a second dielectric member 34 to define discharge cells 18R, 18G and 18B. The first dielectric member 33 and the second dielectric member 34 may be disposed to intersect each other.

The first dielectric member 33 may be extended in a second direction (x-axis direction in the drawings) crossing the address electrodes, and may be disposed parallel to adjacent first dielectric members 33 along a first direction (y-axis direction in the drawings) in which the address electrodes are extended. Therefore, the first dielectric members 33 that are adjacent to each other in the first direction (y-axis direction in the drawings) may be a reference for defining discharge cells 18R, 18G and 18B.

The second dielectric member 34 may be extended in the first direction (y-axis direction in the drawings) and alternately disposed between the first dielectric members 33 to interconnect adjacent first dielectric members 33 in the first direction. Also, the second dielectric member 34 may be disposed parallel with adjacent second dielectric members 34 in the second direction (x-axis direction in the drawings) and alternately disposed along the first direction (y-axis direction in the drawings). Therefore, the second dielectric members 34 may be a reference for defining discharge cells 18R, 18G and 18B that are adjacent to each other in the second direction (x-axis direction in the drawings).

By the first dielectric member 33 and the second dielectric member 34, discharge cells 18R, 18G and 18B forming a pixel may be disposed in a triangular pattern or configuration.

In addition, according to the shape or shapes of the first dielectric member 33 and the second dielectric member 34, the dielectric layer 30 may form the discharge cells 18 in various shapes, e.g., a quadrilateral shape. In the present embodiment, the first dielectric member 33 and the second dielectric member 34 are formed in stripe patterns, thereby forming the discharge cells 18 in a rectangular shape. When the length of the first dielectric member 33 is equal to that of the second dielectric member 34, the discharge cells 18 are formed in a shape of square.

In addition, the rear-plate barrier rib layer 16 and the front-plate barrier rib layer 26 disposed on both sides of the dielectric layer 30 may form discharge cells 18R, 18G and 18B in a rectangular shape. Specifically, the rear-plate barrier rib layer 16 may include first barrier rib members 116 and second barrier rib members 216 that face the dielectric layer 30. The first barrier rib members 116 may be formed to extend in the first direction (x-axis direction in the drawings) on an inner surface of the rear substrate 10, and may be formed in parallel with and along the first dielectric members 33. The second barrier rib members 216 may be formed in parallel with and along the second dielectric members 34, and may connect the adjacent first barrier rib members 116 to each other. The adjacent second barrier rib members 216 along the second direction (x-axis direction in the drawings) may be formed in parallel with each another, and may be alternately disposed along the first direction (y-axis direction in the drawings). Therefore, the second barrier rib members 216 may be references for defining the discharge cells 18R, 18G, and 18B in the second direction (x-axis direction in the drawings). By the first barrier rib members 116 and the second barrier rib members 216, discharge cells 18R, 18G, and 18B may be formed and disposed in a triangular pattern or configuration to form a pixel of the display panel of the present invention.

The front-plate barrier rib layer 26 may include the third barrier rib members 126 and the fourth barrier rib members 226 that face the dielectric layer 30. The third barrier rib members 126 may be formed to extend in the first direction (x-axis direction in the drawings) on an inner surface of the front substrate 20, and may be formed in parallel with and along the first dielectric members 33. The fourth barrier rib members 226 may be formed in parallel with and along the second dielectric members 34, and may connect the adjacent third barrier rib members 126 to each other. The adjacent fourth barrier rib members 226 along the second direction (x-axis direction in the drawings) may be formed in parallel with each another, and may be alternately disposed along the first direction (y-axis direction in the drawings). Therefore, the fourth barrier rib members 226 may be references for defining the discharge cells 18R, 18G, and 18B in the second direction (x-axis direction in the drawings). By the third barrier rib members 126 and the fourth barrier rib members 226, discharge cells 18R, 18G, and 18B may be formed and disposed in a triangular pattern or configuration to form a pixel of the display panel of the present invention.

As such, the first discharge space 117 defined by the rear-plate barrier rib layer 16, the main discharge space 17 defined by the dielectric layer 30, and the second discharge space 217 defined by the front-plate barrier rib layer 26 may be connected to one another, and thereby form the discharge cell 18. Moreover, the discharge cells 18 forming each pixel may be disposed in a triangular pattern or configuration.

In the case where the rear-plate barrier rib layer 16 and the front-plate barrier rib layer 26 may not be provided in the PDP, the phosphor layer 19 may be formed on a surface of the rear substrate 10 and/or the phosphor layer 29 may be formed on a surface of the front substrate 20. In addition, phosphor layers may also be formed on a portion of or all of an inner surface of the dielectric layer 30 forming side walls of the main discharge space 17.

Hereinafter, the PDP with the rear-plate barrier rib layer 16 and the front-plate barrier rib layer 26 will be explained and described as an example. The phosphor layer 19 may be formed on the rear-plate barrier rib layer 16 and the rear substrate 10 and/or the phosphor layer 29 may be formed on the front-plate barrier rib layer 26 and the front substrate 20.

The phosphor layers 19 and 29 may include a first phosphor layer 19 formed on the rear substrate 10 and a second phosphor layer 29 formed on the front substrate 20. The first phosphor layer 19 formed in the rear-plate barrier rib layer 16 may be formed on the rear substrate 10 and the side surfaces of the rear-plate barrier rib layer 16 defining the first discharge space 117. The address electrode 11 may be substantially provided on the rear substrate 10, and the address electrode 11 may be covered with a dielectric layer 13. Thus, the first phosphor layer 19 may be formed on a surface of the dielectric layer 13 defining the first discharge space 117. The dielectric layer 13 serves to protect the address electrode 11 and to attach wall charges thereto. The second phosphor layer 29 formed in the front-plate barrier rib layer 26 may be formed on the front substrate 20 and the side surface of the front-plate barrier rib layer 26 defining the second discharge space 217.

Preferably, the volume of the second discharge space 217 defined by the front-plate barrier rib layer 26 is greater than the volume of the first discharge space 117 defined by the rear-plate barrier rib layer 16. That is, the volumes of discharge spaces 117 and 217 determine each area of the first phosphor layer 19 and the second phosphor layer 29, and each area of the first phosphor layer 19 and the second phosphor layer 29 determines the amount of visible light. Thus, in order to increase luminous efficiency, it is preferable that the volume of the second discharge space 217 at the front substrate 10 where visible light is transmitted is larger than the volume of the first discharge space 117 at the rear substrate 20 where visible light is reflected.

The first phosphor layer 19 may absorb VUV light in the first discharge space 117 and may emit visible light toward the front substrate 20. The second phosphor layer 29 may absorb VUV rays in the second discharge space 217 and may emit visible light toward the front substrate 20. For this purpose, the first phosphor layer 19 may be made of reflective phosphors that reflect visible light, and the second phosphor layer 29 may be made of transmissive phosphors that transmit visible light. In addition, a thickness t₁ of the first phosphor layer 19 in the rear substrate 10 may be formed to be larger than a thickness t₂ of the second phosphor layer 29 in the front substrate 20. That is, each particle size of phosphor powders forming the first phosphor layer 19 may be larger than each particle size of phosphor powders forming the second phosphor layer 29. Thus, the thickness difference between the first phosphor layer 19 and the second phosphor layer 29 can minimize the loss of VUV light and increase luminous efficiency.

The first phosphor layer 19 may be formed on side surfaces of the first barrier rib members 116 and the second barrier rib members 216, and on the dielectric layer 13 corresponding to the first discharge space 117. The second phosphor layer 29 may be formed on side surfaces of the third barrier rib members 126 and the fourth barrier rib members 226, and on the front substrate 20 corresponding to the second discharge space 217.

The first phosphor layer 19 may be formed by forming the rear-plate barrier rib layer 16 on the rear substrate 10, and then coating phosphor material on the rear-plate barrier rib layer 16. Alternatively, the first phosphor layer 19 may be formed by etching the rear substrate 10 to correspond to the shape of the first discharge space 117, and then coating phosphor material on etched surfaces of the rear substrate 10. The second phosphor layer 29 may be formed by forming the front-plate barrier rib layer 26 on the front substrate 10, and then coating phosphor material on the front-plate barrier rib layer 26. Alternatively, the second phosphor layer 29 may be formed by etching the front substrate 20 to correspond to the shape of second discharge space 217, and then coating phosphor material on etched surfaces of the front substrate 20.

In the case where the rear-plate barrier rib layer 16 is formed by etching the rear substrate 10, the rear substrate 10 and the rear-plate barrier rib layer 16 may be made of the same material. In addition, in the case where the front-plate barrier rib layer 26 is formed by etching the front substrate 20, the front substrate 20 and the front-plate barrier rib layer 26 may be made of the same material. The etching method can lower the manufacturing cost of the PDP compared to a method of forming the rear-plate barrier rib layer 16 and the rear substrate 10 separately and forming the front-plate barrier rib layer 26 and the front substrate 20 separately.

The sustain electrodes 31 and the scan electrodes 32 may be extended in the second direction (x-axis direction in the drawings), and may be alternately disposed along the first direction (y-axis direction in the drawings). That is, the sustain electrodes 31 and the scan electrode 32 may be buried in the first dielectric material member 33 of the dielectric layer 30, and may be shared by adjacent discharge cells 18R, 18G, and 18B in the first direction (y-axis direction in the drawings). Thus, each of the sustain electrode 31 and the scan electrodes 32 may participate in sustain discharge of adjacent discharge cells 18R, 18G, and 18B in the first direction.

In the present embodiment, the sustain electrodes 31 and the scan electrodes 32 may be disposed between the first substrate 10 and the second substrate 20, and may be opposite to each other with the discharge cell 18 therebetween. Since the sustain electrodes 31 and the scan electrodes 32 may be configured to have such an opposed discharge structure, the discharge firing voltage for sustain discharge can be reduced.

In addition, in cross-sections of the sustain electrode 31 and the scan electrode 32, a vertical direction h measured in a direction perpendicular to the substrates 10 and 20 may be greater than a horizontal length w measured in the first direction (y-axis direction in the drawings).

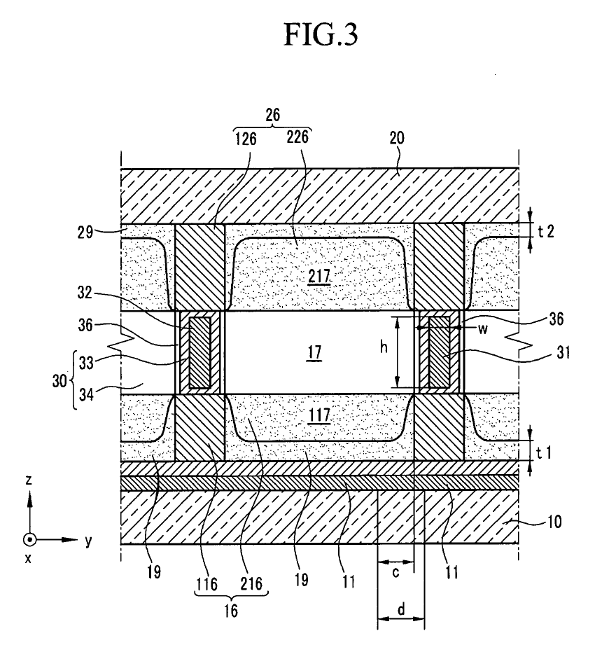

By this structure, an opposed discharge between the sustain electrode 31 and the scan electrode 32 may be easily induced, thereby obtaining higher luminous efficiency (see FIG. 3).

The sustain electrode 31 and the scan electrode 32 may be buried in the first dielectric member 33 disposed in a non-discharge area, and may be disposed between the first barrier rib members 116 and the third barrier rib members 126. Thus, visible light emitted from the main discharge space 17 is not blocked by the sustain discharge electrode 31 and the scan electrode 32, and thereby the sustain electrode 31 and the scan electrode 32 can be made of a non-transparent material having excellent conductivity, e.g., a metal.

The sustain electrode 31 and the scan electrode 32 may be buried in the dielectric layer 30. The dielectric layer 30 serves to accumulate wall charges thereon and to insulate the sustain electrode 31 and the scan electrode 32. The sustain electrode 31 and the scan electrode 32 may be manufactured by a Thick Film Ceramic Sheet (TFCS) method. That is, the dielectric layer 30 including the sustain electrode 31 and the scan electrode 32 may be separately made, and may then be coupled to the rear substrate 10 having the rear-plate barrier rib layer 16 formed thereon.

Specifically, the sustain electrode 31 and the scan electrode 32 may be made by a printing method or an ink-jet method, and then a dielectric material may be used to fill between the sustain electrode 31 and the scan electrode 32 by a printing method. Thereafter, a portion of the dielectric material corresponding to the main discharge space 17 may be etched by a sandblasting method to thereby form and manufacture the sustain electrode 31 and the scan electrode 32 buried in the dielectric layer 30.

Alternatively, the sustain electrode 31 and the scan electrode 32 may be made by a printing method or an ink-jet method, and then a photosensitive dielectric material may be used to fill between the sustain electrode 31 and the scan electrode 32. Thereafter, a portion of the photosensitive dielectric material corresponding to the main discharge space 17 may be etched, thereby forming and manufacturing the sustain electrode 31 and the scan electrode 32 buried in the dielectric layer 30.

A protective layer 36 may be formed on the surfaces of the dielectric layer 30. Particularly, the protective layer 36 may be formed on a portion that is exposed to the plasma discharge generated in the main discharge space 17. The protective layer 36 may protect the dielectric layer 30 and may have a high secondary electron emission coefficient. However, the protective layer 36 in the present exemplary embodiment may or may not be transparent. That is, since the sustain electrode 31 and the scan electrode 32 are not formed on the front substrate 20 or the rear substrate 10, but are formed between the front substrate 20 and the rear substrate 10 in the dielectric layer 30, the protective layer 36, which is coated on the dielectric layer 30 covering the sustain electrode 31 and the scan electrode 32, may be formed of a non-transparent material. For example, the protective layer 36 may be made of non-transparent MgO. The non-transparent MgO has a higher secondary electron emission coefficient compared to transparent MgO, thereby further reducing the discharge firing voltage.

FIG. 3 shows that a vertical length of the first dielectric member 33 may be equal to a vertical length of the second dielectric member 34 in the direction (z-axis direction) perpendicular to the substrates 10 and 20. However, in the present exemplary embodiment, the discharge cells 18R, 18G, and 18B are arranged in a triangular pattern or configuration, and the main discharge space 17 defined by the dielectric layer 30, the first discharge space 117 defined by the rear-plate barrier rib layer 16, and the second discharge space 217 defined by the front-plate barrier rib layer 26 may be formed as a closed space. Thus, exhaust performance needs to be considered, so the vertical length of the first dielectric member 33 may be different from a vertical length of the second dielectric member 34 in order to form exhaust passages.

The discharge cells 18R, 18G, and 18B forming each pixel may be arranged in a triangular pattern or configuration by the dielectric layer 30, and the address electrodes 11 may be extended in the first direction (y-axis direction in the drawings). Thus, the address electrode 11 may be disposed to alternately cross a non-discharge space such as the dielectric layer 30 and the main discharge space 17.

As described above, the second dielectric member 34 may be alternately formed along the first direction (y-axis direction in the drawings), and the discharge cells 18R, 18G, and 18B defined by the first and second dielectric member 33 and 34 may be arranged in a triangular pattern or configuration. Accordingly, the address electrode 11 extending in the first direction (y-axis direction in the drawings) may be formed to pass by the second dielectric member 34 and the main discharge space 17 alternately. In a portion of the address electrode 11 passing by the second dielectric member 34, a discharge space where address discharge is performed is not formed between the address electrode 11 and the scan electrode 32, and thereby discharge cells 18R, 18G, and 18B to be turned on are not selected.

At a portion of the address electrode 11 passing by the main discharge space 17, the main discharge space 17 where address discharge is performed may be formed between the address electrode 11 and the scan electrode 32, and thereby discharge cells 18R, 18G, and 18B to be turned on can be selected. That is, the address electrode 11 may participate in address discharge of the discharge cells alternately arranged in the first direction (y-axis direction in the drawings).

The address electrode 11 may be formed on the rear substrate 10 where visible light is reflected, thereby not blocking visible light directed toward the front substrate 20. Therefore, the address electrode 11 can be made of a non-transparent material having excellent conductivity, e.g., a metal.

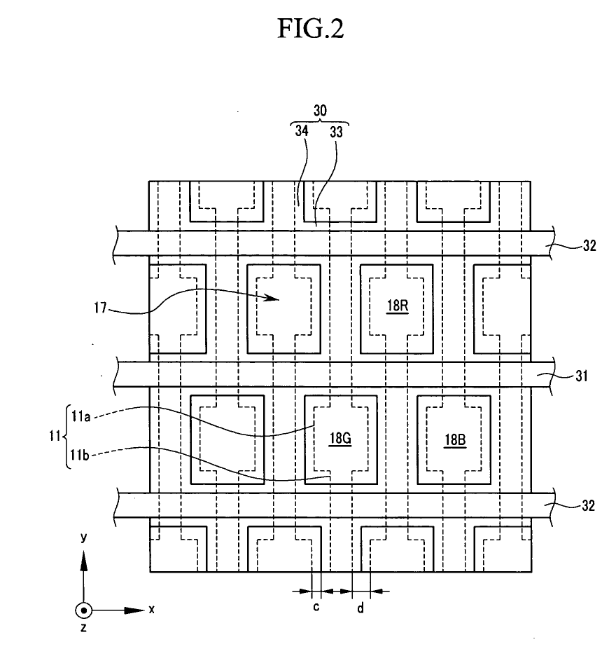

The address electrode 11 may be of various shapes and sizes. For instance, as shown in FIG. 2, the address electrode 11 may include a large electrode portion 11a and a small electrode portion 11b that are alternately formed along the first direction (y-axis direction in the drawings) and connected to each other. The small electrode portion 11b may extend adjacent the second dielectric member 34 of the dielectric layer 30. The large electrode portion 11a that has a greater width than that of the small electrode portion 11b may be positioned to correspond to the discharge cells 18R, 18G, and 18B and may be connected to the small electrode portion 11b, i.e., the large electrode portion 11a formed on the rear substrate 10 may be correspondingly underneath the discharge cells 18R, 18G, and 18B in the z-axis direction.

Since the small electrode portion 11b may extend along and may be adjacent the second dielectric member 34, the small electrode portion 11b may not participate in address discharges in adjacent discharge cells 18R, 18G, and 18B in the second direction (x-axis direction in the drawings) with the small electrode portion 11b interposed therebetween. Since the large electrode portion 11a is correspondingly underneath the discharge cells 18R, 18G, and 18B, the large electrode portion 11a may participate in address discharge with the scan electrode 32 disposed at one side of the main discharge space 17, and thereby select discharge cells 18R, 18G, and 18B to be turned on. The large electrode portion 11a may increase a facing area between the address electrode 11 and the scan electrode 21, and may thereby facilitate and enhance the address discharge.

As a distance d between adjacent address electrodes 11 in the second direction (x-axis direction in the drawings) decreases, energy loss by circuit components that apply voltage to the address electrodes 11 increases. In order to minimize this energy loss, and facilitate and enhance address discharge, a gap c may be formed between an external circumference of the large electrode portion 11a and an internal circumference of the discharge cells 18R, 18B, and 18G in the second direction (x-axis direction in the drawings). The distance d between adjacent address electrodes 11, i.e., the distance d between an adjacent large electrode portion 11a and a small electrode portion 11b in the second direction (x-axis direction in the drawings), may be formed to be larger by virtue of gap c.

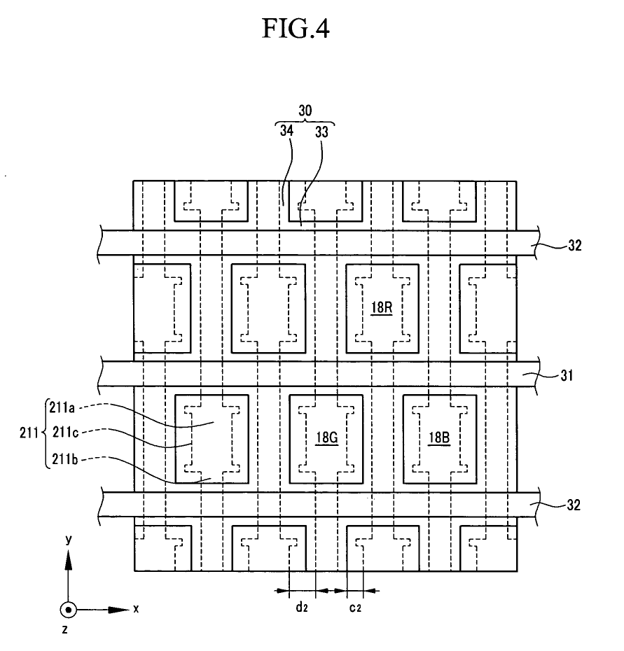

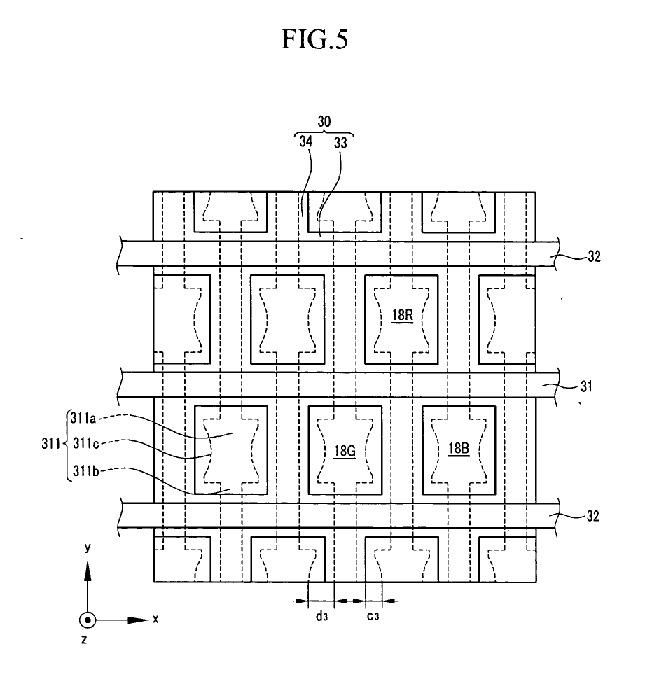

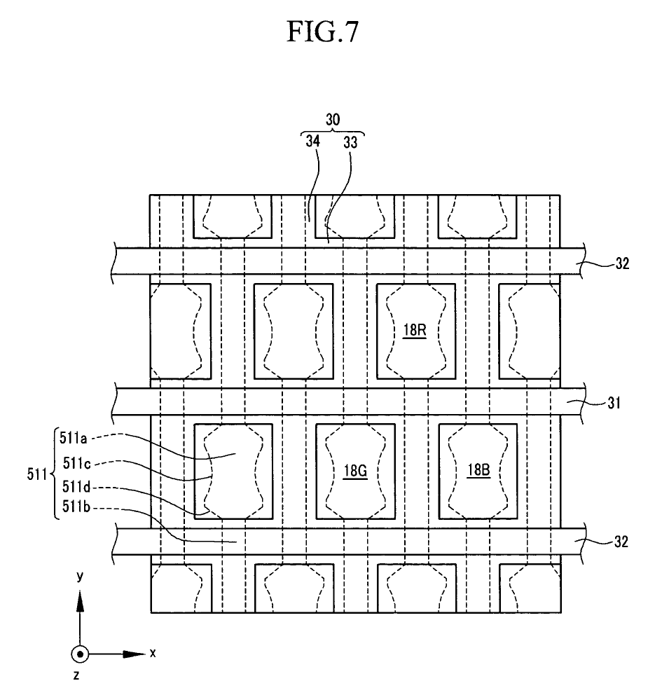

In addition, in the second direction (x-axis direction in the drawings), a width of the large electrode portion 11a corresponding to the central area of the discharge cells 18R, 18B, and 18G may be smaller than a width of the large electrode portion 11a adjacent to the sustain electrode 31 or the scan electrode 32 (see FIG. 4, FIG. 5, and FIG. 7).

FIGS. 4 to 9 illustrate schematic partial plan views of the structure of electrodes and discharge cells in a PDP according to second to seventh exemplary embodiments, respectively, of the present invention.

The second to seventh exemplary embodiments of the present invention may have the same basic structure or similar basic structures to that of the first exemplary embodiment of the present invention, and thus detailed descriptions regarding the same or similar part thereof will be omitted, and portions different from those of the first exemplary embodiment will be described in further detail.

Referring to FIG. 4, an address electrode 211 according to the second exemplary embodiment may include a large electrode portion 211a, a small electrode portion 211b, and a groove 211c. The groove or notch 211c may be formed along the edge of one (not shown) or both (as shown in FIG. 4) sides of the large electrode portion 211a in the second direction (x-axis direction in the drawings). Therefore, a gap c2 between the external circumference of the large electrode portion 211a and the internal circumference of the discharge cells 18R, 18G and 18B, may increase, and thereby increase a distance d2 between the adjacent large electrode portion 211a and the small electrode portion 211b. By the address electrode 211 having the above structure, energy loss from circuit components can be further reduced.

In addition, address discharge mainly occurs at each center of the discharge cells 18R, 18G and 18B, rather than at a portion of the discharge cells 18R, 18G and 18B adjacent to the scan electrode 32. Therefore, address discharge in the second exemplary embodiment of the present invention may be easily performed because an area of the large electrode portion 211a adjacent to the scan electrode 32 is greater than an area of the large electrode portion 211a corresponding to each center of the discharge cells 18R, 18G, and 18B.

Referring to FIG. 5, an address electrode 311 according to the third exemplary embodiment includes a large electrode portion 311a, a small electrode portion 311b, and a groove or curved notch 311c. The groove 311c may be formed in an arc shape at both sides of the large electrode portion 311a in the second direction (x-axis direction in the drawings). In more detail, the arc part of the groove 311c may be formed to be concave toward the outside of each discharge cell 18R, 18G and 18B. Therefore, a gap c3 between the external circumference of the large electrode portion 311a and the internal circumference of the discharge cells 18R, 18G and 18B increases, thereby increasing a distance d3 between the adjacent large electrode portion 311a and the small electrode portion 311b. The groove 311c having an arc shape operates similarly to the groove 211c formed along the edge

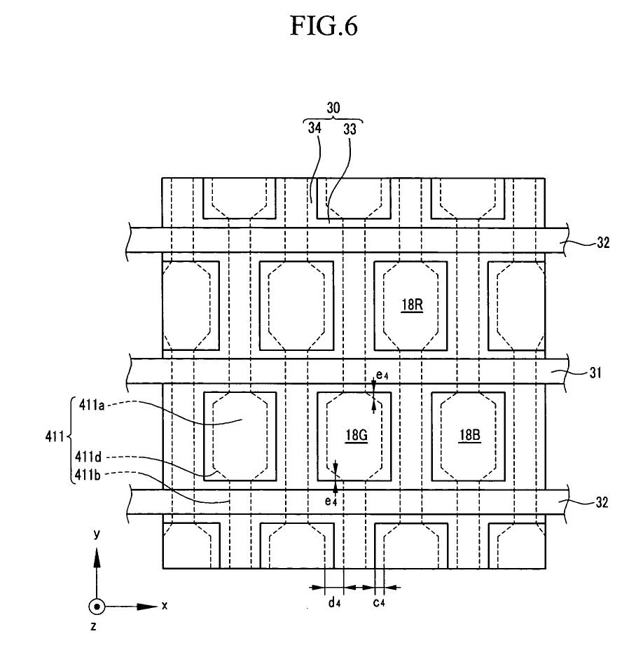

Referring to FIG. 6, an address electrode 411 according to the fourth exemplary embodiment may include a large electrode portion 411a, a small electrode portion 411b, and a transitional electrode portion 411d. That is, the transitional electrode portion 411d may be formed between the large electrode portion 411a and the small electrode portion 411b, and a gap e4 in the first direction (y-axis direction in the drawings) between the sustain electrode 31 and the transitional electrode portion 411d or between the scan electrode 32 and the transitional electrode portion 411d may be varied along the second direction (x-axis direction in the drawings). Specifically, a portion of the large electrode portion 411a corresponding to the sustain electrode 31 or the scan electrode 32 may be formed to be inclined, and the gap e4 increases from the center of each discharge cell 18R, 18G and 18B toward the outside thereof. Gap c4 between the external circumference of the large electrode portion 411a and the internal circumference of the discharge cells 18R, 18G and 18B, remains the same as does a distance d4 between the adjacent large electrode portion 411a and the small electrode portion 411b.

Referring to FIG. 7, an address electrode 511 according to the fifth exemplary embodiment may include a large electrode portion 511a, a small electrode portion 511b, a groove or notch 511c, and a transitional electrode portion 511d. That is, the address electrode 511 may further include the groove 511c having an arc shape, as opposed to the fourth exemplary embodiment.

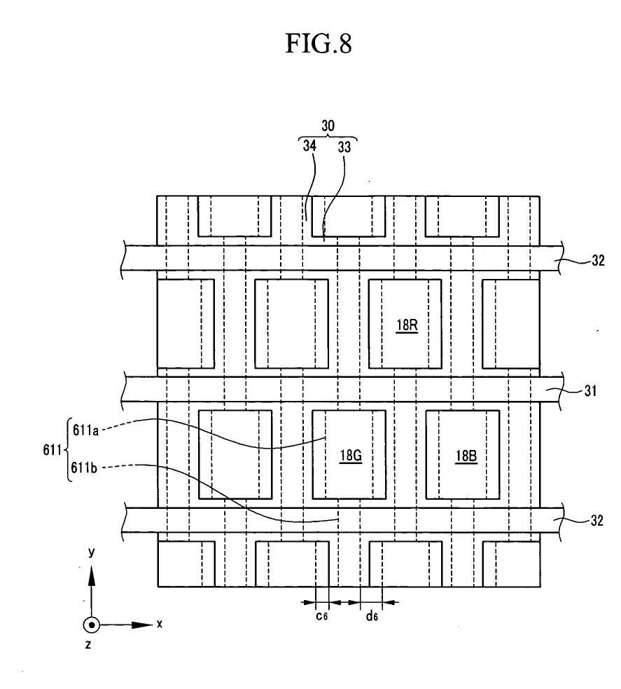

Referring to FIG. 8, an address electrode 611 according to the sixth exemplary embodiment may include a large electrode portion 611a and a small electrode portion 611b. In addition, the large electrode portion 611a may be formed in a shape of a straight line in the first direction (y-axis direction in the drawings), and a width of the large electrode portion 611a in each discharge cell 18R, 18G, and 18B may be constant. That is, a gap c6 between the external circumference of the large electrode portion 611a and the internal circumference of each discharge cell 18R, 18G, and 18B may be constantly maintained in each discharge cell 18R, 18G, and 18B, thereby constantly maintaining a distance d6 between the adjacent large electrode portion 611a and the small electrode portion 611b.

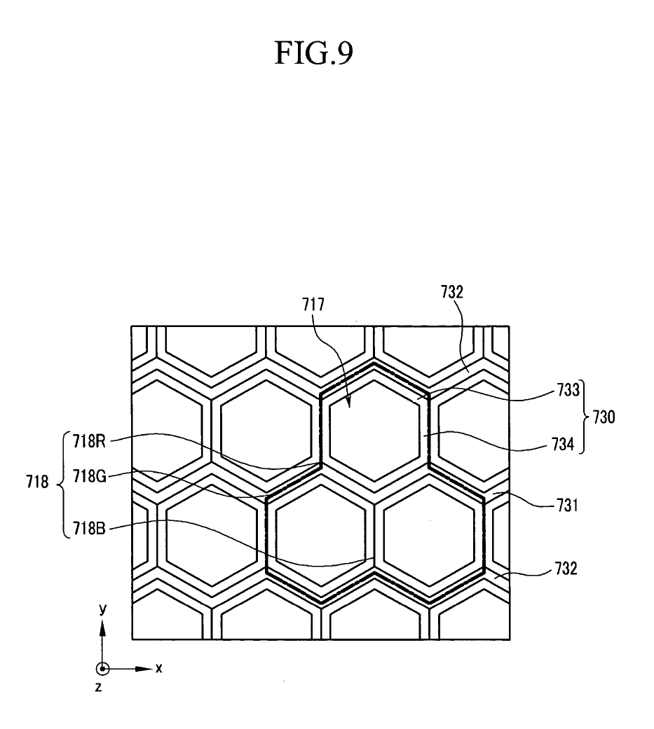

Referring to FIG. 9, a PDP according to the seventh exemplary embodiment may have a structure similar to the above exemplary embodiments, and may operate similarly with respect thereto except that discharge cells 718R, 718G, and 718B may be formed in a hexagonal shape. That is, a dielectric layer 730 may include a first dielectric member 733 formed in a zigzag pattern and a second dielectric member 734 formed in a shape of a straight line. By the first and second dielectric member 733 and 734, the discharge cells 718 and a discharge space 717 may be formed in a hexagonal shape. In addition, sustain electrodes 731 and scan electrodes 732 buried in the first dielectric member 733 may be formed in a zigzag pattern corresponding to the zigzag pattern of the first dielectric member 733. Further, address electrodes as in the first to the sixth exemplary embodiments may be included in the PDP.

As described above, in the PDP according to the exemplary embodiments of the present invention, discharge cells may be defined by a dielectric layer between a rear substrate and a front substrate, and discharge cells forming each pixel may be disposed in a triangular pattern or configuration. In addition, address electrodes may be formed on the rear substrate, and a portion thereof may be formed under the dielectric layer. Sustain and scan electrodes that are extended in a direction crossing the address electrodes may be buried in the dielectric layer and may be alternately arranged in direction, and thereby shared between adjacent discharges. Thus, an opposed discharge can occur between the sustain and scan electrodes in the adjacent discharge cells in the direction of the address electrodes and can be independently controlled.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
a first substrate and a second substrate arranged opposite to each other;
a dielectric layer defining a plurality of discharge cells between the first substrate and the second substrate, with at least three discharge cells forming a display pixel of the display panel being disposed in a triangular pattern;
a phosphor layer in each discharge cell;
address electrodes extending in a first direction between the first substrate and the second substrate, with each discharge cell of the at least three discharge cells forming the display pixel of the display panel being paired with a different address electrode; and
a first electrode and a second electrode, disposed opposite and spaced apart from each other in the dielectric layer, and extending in a second direction crossing the first direction.

2. The plasma display panel as claimed in claim 1, wherein the dielectric layer comprises first dielectric members extending in the second direction, and
second dielectric members alternately disposed along the first direction between the first dielectric members and connecting the first dielectric members to each other.

3. The plasma display panel as claimed in claim 2, wherein each address electrode includes a small electrode portion and a large electrode portion, the small electrode portion being adjacent the second dielectric members and the large electrode portion being adjacent the discharge cells.

4. The plasma display panel as claimed in claim 3, further comprising a gap between an external circumference of the large electrode portion and an internal circumference of the discharge cell.

5. The plasma display panel as claimed in claim 4, wherein a width of the large electrode portion corresponding to a center of the discharge cell is less than a width of the large electrode portion adjacent to the first electrodes or the second electrodes, the width being measured in the second direction.

6. The plasma display panel as claimed in claim 4, wherein the address electrodes further comprise a groove along a side of the large electrode portion extending in the first direction.

7. The plasma display panel as claimed in claim 6, wherein the groove is arc shaped.

8. The plasma display panel as claimed in claim 4, wherein the address electrodes further comprise a transitional electrode portion formed between the large electrode portion and the small electrode portion.

9. The plasma display panel as claimed in claim 8, wherein the address electrodes further comprise an arc shaped groove along a side of the large electrode portion extending in the first direction.

10. The plasma display panel as claimed in claim 4, wherein at least one side of the large electrode portion in the first direction is straight and a width of the large electrode portion in each discharge cell is constant.

11. The plasma display panel as claimed in claim 1, wherein the discharge cells have a quadrilateral shape.

12. The plasma display panel as claimed in claim 1, wherein the discharge cells have a hexagonal shape.

13. The plasma display panel as claimed in claim 12, wherein the first electrode and the second electrode are formed in a zigzag pattern along circumferences of the discharge cells and extend in the second direction.

14. The plasma display panel as claimed in claim 2, further comprising a first barrier rib layer disposed adjacent to the first substrate,
wherein the dielectric layer defines a main discharge space and the first barrier rib layer defines a first discharge space in corresponding relationship with the main discharge space.

15. The plasma display panel as claimed in claim 14, further comprising a second barrier rib layer disposed adjacent to the second substrate,
wherein the second barrier rib layer defines a second discharge space in corresponding relationship with the first discharge space with the main discharge space interposed therebetween.

16. The plasma display panel as claimed in claim 15, wherein a volume of the second discharge space is greater than a volume of the first discharge space.

17. The plasma display panel as claimed in claim 15, wherein the first barrier rib layer comprises first barrier rib members in parallel with the first dielectric members, and second barrier rib members in parallel with the second dielectric members and alternately connecting adjacent first barrier rib members to each other, and
wherein the second barrier rib layer comprises third barrier rib members in parallel with the first dielectric members and the first barrier rib member, and fourth barrier rib members in parallel with the second dielectric members and the second barrier rib members, and alternately connecting adjacent third barrier rib members to each other.

18. The plasma display panel as claimed in claim 15, wherein the phosphor layer comprises a first phosphor layer in the first discharge space defined by the first barrier rib layer, and a second phosphor layer in the second discharge space defined by the second barrier rib layer; and
wherein the first phosphor layer is a reflective phosphor and the second phosphor layer is a transmissive phosphor.

19. The plasma display panel as claimed in claim 1, wherein the first electrode and the second electrode are a metal.

20. The plasma display panel as claimed in claim 1, wherein the first electrode and the second electrode are disposed at boundaries of adjacent discharge cells across the first direction, and are alternately arranged across the first direction.
